(19) United States
(12) Patent Application Publication
(10) Pub. No.: US 2025/0266420 A1
(43) Pub. Date: Aug. 21, 2025

(54) TEMPO-SPATIAL MANIPULATION OF ULTRASONICS FOR A SOLID-STATE BATTERY

(71) Applicant: GM GLOBAL TECHNOLOGY OPERATIONS LLC, DETROIT, MI (US)

(72) Inventors: Qigui Wang, Rochester Hills, MI (US); Liang Wang, Rochester Hills, MI (US); Lei Chen, Ann Arbor, MI (US); Yaohong Xiao, Dearborn, MI (US); Xinxin Yao, Ann Arbor, MI (US)

(21) Appl. No.: 18/442,309

(22) Filed: Feb. 15, 2024

(51) Int. Cl. H01M 4/04; H01M 4/02; H01M 10/058

(52) U.S. Cl. CPC H01M 4/043; H01M 10/058; H01M 2004/027; H01M 2220/20; H01M 2300/0065

(57) ABSTRACT

Aspects of the disclosure include a tempo-spatial manipulation of ultrasonics (TSMU) for solid-state battery manufacturing and solid-state batteries manufactured using the same. An exemplary vehicle includes an electric motor and a battery pack electrically coupled to the electric motor. The battery pack includes a solid-state battery cell that includes an anode having a major surface, a solid electrolyte in direct contact with the anode, and an interface between the anode and the solid electrolyte. The interface is subjected to TSMU including a first ultrasonics phase at an emission angle parallel to the major surface of the anode, a second ultrasonics phase at an emission angle orthogonal to the major surface of the anode, and a third ultrasonics phase at an emission angle parallel to the major surface of the anode, thereby reducing an air gap between the anode and the solid electrolyte at the interface.

### INTRODUCTION

The present disclosure relates to battery cell manufacturing, and particularly to a tempo-spatial manipulation of ultrasonics (TSMU) for solid-state battery manufacturing.

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

The lithium-ion battery (LIB) has become one of the most common battery chemistries for these and other applications. A typical lithium-ion battery consists of three main components: an anode, often made of graphite, a cathode, often made of lithium cobalt oxide (LiCoO₂), lithium manganese oxide (LiMn₂O₄), or lithium iron phosphate (LiFePO₄), and a liquid electrolyte, commonly a lithium salt dissolved in a solvent, such as ethylene carbonate and dimethyl carbonate. The electrolyte facilitates the movement of lithium ions between the anode and cathode during charge and discharge.

Recently, solid-state batteries have emerged as a potential next-generation replacement for lithium-ion batteries. In a solid-state battery, the conventional liquid electrolyte is substituted with a solid-state material (e.g., a solid electrolyte, SE). The solid electrolyte can take various forms, including ceramics, polymers, or a combination of both. Solid-state batteries offer various advantages over liquid electrolyte-based batteries, such as relatively higher energy densities, longer cycle life, wider operational temperature ranges, and greater flexibility in design due to their natively thinner and lighter architectures.

### SUMMARY

In one exemplary embodiment a vehicle includes an electric motor and a battery pack electrically coupled to the electric motor. The battery pack includes a solid-state battery cell that includes an anode having a major surface, a solid electrolyte in direct contact with the anode, and an interface between the anode and the solid electrolyte. The interface is subjected to TSMU including a first ultrasonics phase at an emission angle parallel to the major surface of the anode, a second ultrasonics phase at an emission angle orthogonal to the major surface of the anode, and a third ultrasonics phase at an emission angle parallel to the major surface of the anode, thereby reducing an air gap between the anode and the solid electrolyte at the interface.

In addition to one or more of the features described herein, in some embodiments, the first ultrasonics phase includes a lateral ultrasonics phase, the second ultrasonics phase includes a vertical ultrasonics phase, and the third ultrasonics phase includes a lateral ultrasonics phase.

In some embodiments, the first ultrasonics phase, the second ultrasonics phase, and the third ultrasonics phase occur sequentially.

In some embodiments, the TSMU is completed while the anode and the solid electrolyte are subjected to an applied pressure of less than 20 MPa.

In some embodiments, the TSMU is completed at an ultrasonic power of between 20 W and 70 W.

In some embodiments, the TSMU is completed within a processing time of between 30 seconds and 5 minutes.

In some embodiments, the TSMU includes galvanostatic cycling.

In another exemplary embodiment a solid-state battery cell includes an anode having a major surface, a solid electrolyte in direct contact with the anode, and an interface between the anode and the solid electrolyte. The interface is subjected to TSMU including a first ultrasonics phase at an emission angle parallel to the major surface of the anode, a second ultrasonics phase at an emission angle orthogonal to the major surface of the anode, and a third ultrasonics phase at an emission angle parallel to the major surface of the anode, thereby reducing an air gap between the anode and the solid electrolyte at the interface.

In some embodiments, the first ultrasonics phase includes a lateral ultrasonics phase, the second ultrasonics phase includes a vertical ultrasonics phase, and the third ultrasonics phase includes a lateral ultrasonics phase.

In some embodiments, the first ultrasonics phase, the second ultrasonics phase, and the third ultrasonics phase occur sequentially.

In some embodiments, the TSMU is completed while the anode and the solid electrolyte are subjected to an applied pressure of less than 20 MPa.

In some embodiments, the TSMU is completed at an ultrasonic power of between 20 W and 70 W.

In some embodiments, the TSMU is completed within a processing time of between 30 seconds and 5 minutes.

In some embodiments, the TSMU includes galvanostatic cycling.

In yet another exemplary embodiment a method can include receiving a component that includes an anode, a solid electrolyte, and an interface between the anode and the solid electrolyte. The anode includes a major surface. The method can include subjecting the interface to a first ultrasonics phase at an emission angle parallel to the major surface of the anode, subjecting the interface to a second ultrasonics phase at an emission angle orthogonal to the major surface of the anode, and subjecting the interface to a third ultrasonics phase at an emission angle parallel to the major surface of the anode.

In some embodiments, the first ultrasonics phase includes a lateral ultrasonics phase, the second ultrasonics phase includes a vertical ultrasonics phase, and the third ultrasonics phase includes a lateral ultrasonics phase.

In some embodiments, the first ultrasonics phase, the second ultrasonics phase, and the third ultrasonics phase occur sequentially, thereby defining a tempo-spatial manipulation of ultrasonics (TSMU).

In some embodiments, the TSMU is completed while the component is subjected to an applied pressure of less than 20 MPa.

In some embodiments, the TSMU is completed at an ultrasonic power of between 20 W and 70 W.

In some embodiments, the TSMU is completed within a processing time of between 30 seconds and 5 minutes.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example anode-electrolyte interface before and after a tempo-spatial manipulation of ultrasonics (TSMU) treatment in accordance with one or more embodiments;

FIG. 3A is an example ultrasonics control system for applying TSMU to a battery component in accordance with one or more embodiments;

FIG. 3B is a detailed view of a portion of the ultrasonics control system shown in FIG. 3A in accordance with one or more embodiments;

FIG. 3C is a detailed view of a portion of the ultrasonics control system shown in FIG. 3B in accordance with one or more embodiments;

FIG. 4 is an example TSMU 3-phase lateral-vertical-lateral ultrasonic treatment cycle in accordance with one or more embodiments;

FIG. 5 is a computer system according to one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As the demand for energy storage systems offering higher energy densities, faster charging, and extended operational lifespans increases, driven in part by the proliferation of electric vehicles, significant challenges have been imposed on the materials used in battery cell components. Research and development efforts are continuously directed toward identifying novel materials and manufacturing techniques that can meet escalating demands on battery cells and other energy storage systems. For example, solid-state batteries have been increasingly investigated as a potential next-generation replacement for conventional batteries (e.g., lithium-ion based batteries, such as LFP batteries). In a solid-state battery, the liquid electrolyte is replaced with a solid electrolyte and the anode is typically made of an alkali metal, often lithium metal, although other alkali metals are possible (e.g., Na, K, Zn, and Mg).

Challenges remain, however, in designing and manufacturing solid-state batteries with solid electrolytes. In particular, when manufacturing a solid-state battery, the solid electrolyte is typically sintered to the anode/cathode with a relatively rough surface and thus the contact loss at the interface between the electrolyte and the anode or cathode can be quite significant. This results in an increased interface resistance (e.g., a reduction in ion transport effects) and the uneven deposition/stripping of the metal anode or cathode at the discontinuous contact interface results in the growth of metal dendrites during the electrochemical cycling process and, ultimately, a reduction in battery performance.

This disclosure introduces the use of a tempo-spatial manipulation of ultrasonics for solid-state battery manufacturing. Rather than relying on high-pressure calendering for anode-electrolyte-cathode lamination, ultrasonic vibrations are leveraged to improve the uniformity of metal flatness at the interface between the electrolyte and the anode/cathode. Without wishing to be bound by theory, it is understood that the introduction of ultrasonics while the anode-electrolyte-cathode stack is held under reduced pressures (with respect to the relatively high pressures experienced via conventional pressure rollers) causes the electrode metal to soften, transitioning temporarily to a flowable state with enhanced planar flow, allowing the electrode metal to migrate into any airgaps between the electrolyte and the anode/cathode. This process can be thought of as a sort of ultrasonic plating and, in this manner, contact losses can be minimized. In particular, a tempo-spatial manipulation of ultrasonics (TSMU) is introduced to maximize the propagated energy for ultrasonic plating, while mitigating the possibility of electrolyte cracking. In some embodiments, the TSMU process includes a galvanostatic cycling between three phases: a first lateral ultrasonics treatment phase, a vertical ultrasonics treatment phase, and a second lateral ultrasonics treatment phase.

Leveraging a tempo-spatial manipulation of ultrasonics in accordance with one or more embodiments offers several technical advantages over prior battery manufacturing techniques. Notably, the manufacturing process described herein can be used at lower pressures (e.g., less than 20 MPa) than required for conventional calendering processes (e.g., 100 or even 150 MPa), reducing stresses within the battery stack. Moreover, cycling between the lateral-vertical-lateral ultrasonic treatment phases has been found to increase the bonding index between the electrolyte and the anode/cathode while avoiding the formation of electrolyte cracks that results from a constant vertical ultrasonic treatment. Other advantages are possible. For example, TSMU has been shown to significantly delay battery shortages and the ultrasonic vibration treatments have been shown to occur without a significant temperature rise (less than 50 Celsius, e.g., 40-45 Celsius), mitigating any risk of side reactions.

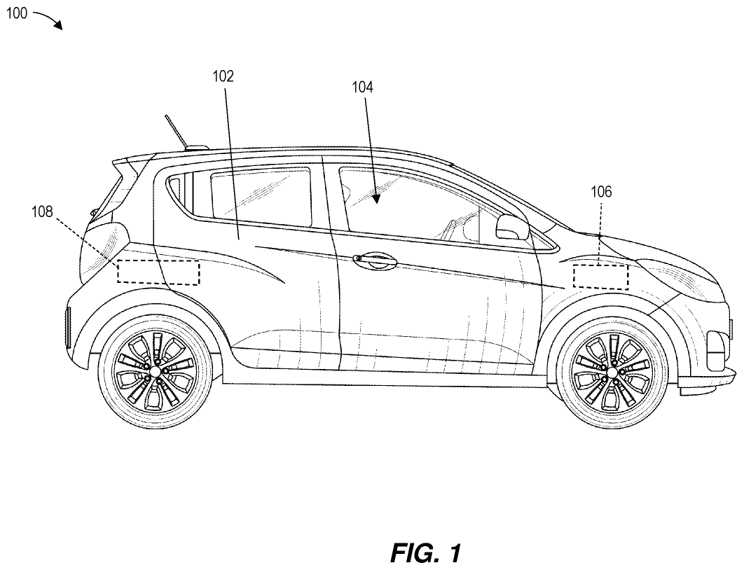

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

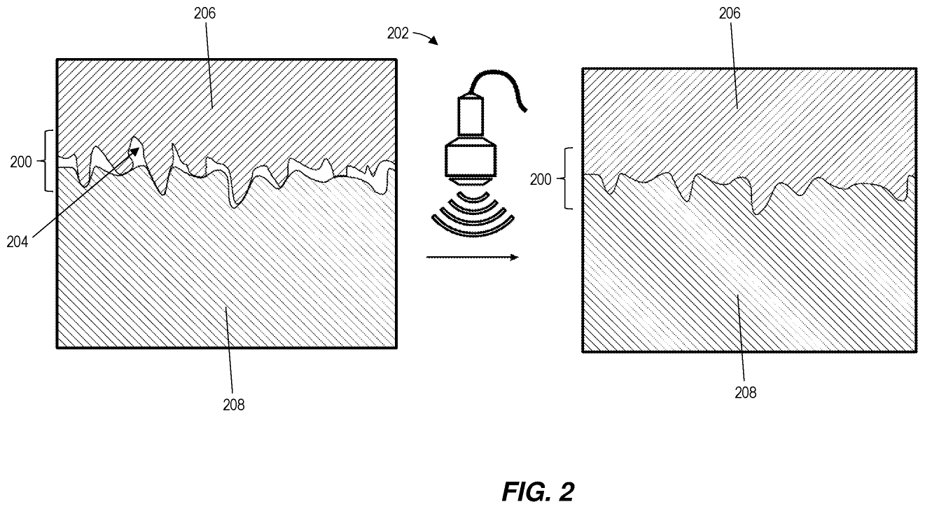

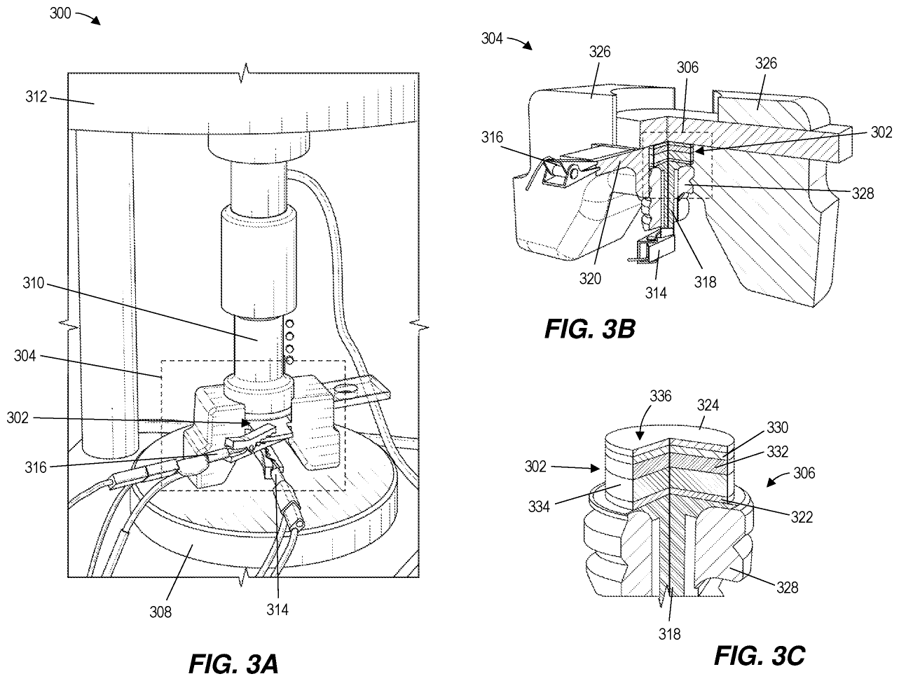

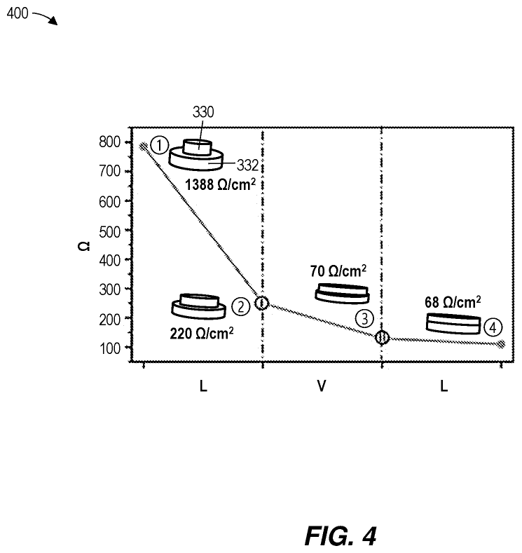

As will be detailed herein, the battery pack 108 includes one or more battery cells and/or battery pouches having a new battery design that leverages TSMU to reduce contact resistance between the anode (or cathode) and an electrolyte. An example anode-electrolyte interface before and after a TSMU treatment is shown in FIG. 2. An example ultrasonics control system for applying TSMU to a battery component is shown in FIGS. 3A, 3B, and 3C. An example TSMU 3-phase lateral-vertical-lateral ultrasonic treatment cycle is shown in FIG. 4.

FIG. 2 illustrates an example anode-electrolyte interface 200 before and after a TSMU treatment 202 in accordance with one or more embodiments. The anode-electrolyte interface 200 can be incorporated within a battery cell of a battery pack (e.g., the battery pack 108 in FIG. 1). While FIG. 2 is discussed primarily with respect to an anode-electrolyte interface, it should be understood that a TSMU treatment can be similarly applied to a cathode-electrolyte interface (omitted for simplicity). Moreover, a single TSMU treatment can be applied simultaneously to the anode-electrolyte interface and the cathode-electrolyte interface.

As shown in FIG. 2, the anode-electrolyte interface 200 prior to the TSMU treatment 202 includes a number of gaps 204 (also referred to as air gaps) between an anode 206 and a solid electrolyte 208. In this configuration, direct contact between the anode 206 and the solid electrolyte 208 is incomplete, resulting in a reduction of ion migration as ions must path around the gaps 204.

As further shown in FIG. 2, the anode-electrolyte interface 200 after the TSMU treatment 202 has been greatly improved, as the gaps 204 have been completely removed (or substantially removed within tooling limits, such as greater than 95% reduction in gaps 204). In other words, direct contact between the anode 206 and the solid electrolyte 208 is greatly improved as compared to the anode-electrolyte interface 200 prior to the TSMU treatment 202. The TSMU treatment 202 is discussed in greater detail with respect to FIG. 4.

FIG. 3A illustrates an example ultrasonics control system 300 for applying TSMU to a battery component 302 in accordance with one or more embodiments. FIG. 3B illustrates a detailed view of a portion 304 of the ultrasonics control system 300 shown in FIG. 3A. FIG. 3C illustrates a detailed view of a portion 306 of the ultrasonics control system 300 shown in FIG. 3B.

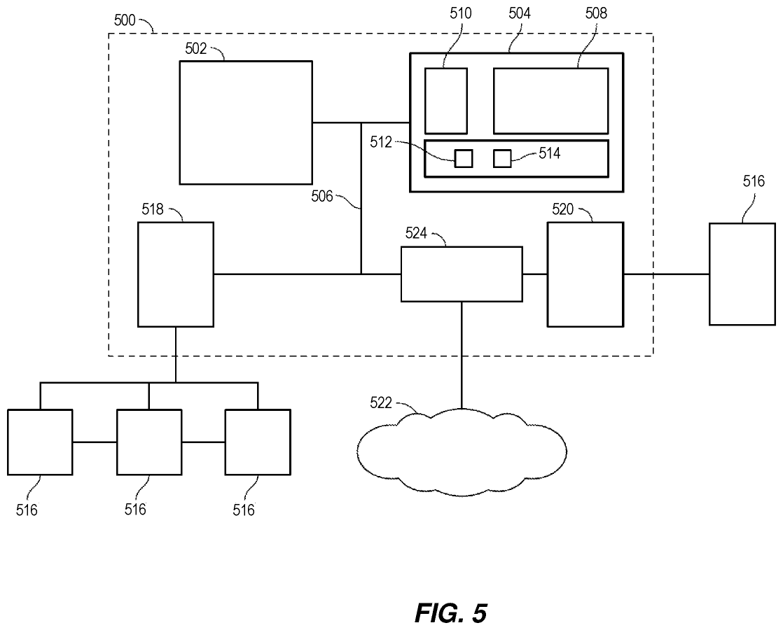

As shown in FIG. 3A, the battery component 302 of the ultrasonics control system 300 is positioned between a force sensor 308 and an ultrasonic control unit 310. In some embodiments, the ultrasonic control unit 310 includes, or is communicatively coupled to, a processor (refer to FIG. 5) for controlling a TSMU treatment (e.g., the TSMU treatment 202 of FIG. 2). The TSMU treatment is discussed in greater detail with respect to FIG. 4.

In some embodiments, a compression device 312 is placed on the ultrasonic control unit 310. In some embodiments, the compression device 312 compresses the battery component 302 to a targeted TSMU pressure, for example, 5 to 15 MPa. While not meant to be particularly limited, the compression device 312 can include, for example, a hydraulic plate or piston, a pressure roller or pair of pressure rollers, and/or a pneumatic actuator. In some embodiments, the ultrasonics control system 300 includes a positive terminal 314 (V+) and a negative terminal 316 (V−). The positive terminal 314 and the negative terminal 316 are positioned to direct a current through the battery component 302 while under pressure applied via the compression device 312. In some embodiments, the ultrasonic control unit 310 directs, via the positive terminal 314 and the negative terminal 316, a constant current density of 0.05 to 10 mA/cm², for example 0.1 mA/cm², across the battery component 302 (that is, the ultrasonic control unit 310 and/or ultrasonics control system 300 can be configured for galvanostatic cycling). Other waveform shapes are possible, for example, pulse waveforms, and all such configurations are within the contemplated scope of this disclosure.

As shown in FIG. 3B, the ultrasonics control system 300 can also include a positive conductor 318 and a negative conductor 320 coupled to the positive terminal 314 and the negative terminal 316, respectively. In some embodiments, the positive conductor 318 is electrically coupled to a cathode current collector 322 (refer to FIG. 3C) of the battery component 302 and the negative conductor 320 is electrically coupled to an anode current collector 324 (refer to FIG. 3C) of the battery component 302. In some embodiments, the battery component 302 is secured between the positive terminal 314 and the negative terminal 316 via one or more clamps 326 and/or a screw 328 (as shown), although other configurations for securing the battery component 302 are within the contemplated scope of this disclosure.

As shown in FIG. 3C, the battery component 302 can include, from top to bottom, the anode current collector 324, an anode 330, a solid electrolyte 332, a cathode 334, and the cathode current collector 322. The anode current collector 324 and the cathode current collector 322 can be made of sheets or foils of conductive metal. For example, the cathode current collector 322 can be made of aluminum foil, stainless steel, and/or titanium foil. Other materials are possible, such as, for example, semimetals (e.g., tin, graphite) and alloys of the metals and/or semimetals thereof. In some embodiments, the cathode current collector 322 is made of aluminum foil. The anode current collector 324 can include, for example, copper foil and/or one or more graphene layers.

The anode 330 and the cathode 334 are not meant to be particularly limited, but can include, for example, various anode or cathode materials, such as, for example, activated carbon powder, nickel manganese cobalt oxide (NMC), lithium iron phosphate (LFP), nickel cobalt aluminum oxide (NCA), nickel cobalt manganese aluminum oxide (NCMA), lithium manganese iron phosphate (LMFP), lithium manganese rich (LMR), lithium manganese oxide (LiMn₂O₄, LMO), graphite, silicon, silicon-graphite composites, tin, tin oxide (SnO₂), lithium titanate (Li₄Ti₅O₁₂, LTO), sulfur and lithium-sulfur (Li—S) composites, lithium metal (Li), and/or lithium alloys such as lithium-antimony (Li—Sb), lithium-aluminum (Li—Al), and lithium-germanium (Li—Ge). In some embodiments, the anode 330 is an alkali metal anode such as a lithium metal (Li) anode and/or a sodium metal (Na) anode. In some embodiments, the cathode 334 is a transition metal oxide such as lithium cobalt oxide (LiCoO₂) and/or rhombohedral Na₃V₂(PO₄)₃ (referred to as NVP).

The solid electrolyte 332 is not meant to be particularly limited, but can include, for example, various ceramics and polymers such as polyethylene oxide-based polymers, as well as lithium phosphorous oxynitride (LiPON), sulfide-based solid electrolytes such as lithium germanium phosphorus sulfide (Li₁₀GeP₂S₁₂), oxide-based solid electrolytes such as lithium lanthanum zirconium oxide (Li₇La₃Zr₂O₁₂, LLZO) and lithium lanthanum zirconium tantalum oxide (Li_{6.4}La₃Zr_{1.4}Ta_{0.6}O₁₂), NASICON-type solid electrolytes (e.g., Li_{1.3}Al_{0.3}Ti_{1.7}(PO₄)₃), and sodium-based composites such as Na₃Zr₂Si₂PO₁₂ (referred to as NZSP).

FIG. 4 illustrates an example TSMU 3-phase lateral-vertical-lateral (LVL) ultrasonic treatment cycle 400 (hereinafter, TSMU 400) in accordance with one or more embodiments. As shown in FIG. 4, TSMU 400 begins at step 1 (denoted via the stylized \textcircled{1}). Step 1 represents the initial (incoming) provision of a battery component, such as the battery component 302 of FIGS. 3A, 3B, and 3C. The interfacial resistance (Ω) is relatively high at this point, for example, approximately 790 Ω, with a resistance per unit area of 1388 Ω/cm².

As further shown in FIG. 4, between step 1 and step 2 (denoted via the stylized \textcircled{2}), the battery component is subjected to a first lateral-phase ultrasonic treatment (via, e.g., the ultrasonics control system 300 of FIG. 3A). As used herein, a “lateral-phase” ultrasonic treatment refers to the application of ultrasonics at a delivery angle parallel to a major surface 336 of the anode of the battery component (refer to FIG. 3C). In some embodiments, the first lateral-phase ultrasonic treatment occurs when the battery component is held under an applied pressure of less than 20 MPa, for example, 5 to 15 MPa. In some embodiments, the first lateral-phase ultrasonic treatment occurs at an ultrasonic power of between 20 W and 70 W. In some embodiments, the first lateral-phase ultrasonic treatment results in an interface temperature of less than 60 C, for example, between 40 C and 45 C. In some embodiments, the first lateral-phase ultrasonic treatment occurs for a processing time of between 30 seconds and 5 minutes. In some embodiments, the first lateral-phase ultrasonic treatment occurs at a frequency between 50 kHz (at 70 W) and 200 kHz (at 20 W).

Step 2 represents the battery component after the first lateral-phase ultrasonic treatment. The interfacial resistance (Ω) is substantially lowered, for example, to 250 Ω, with a resistance per unit area of 220 Ω/cm².

As further shown in FIG. 4, between step 2 and step 3 (denoted via the stylized \textcircled{3}), the battery component is subjected to a vertical-phase ultrasonic treatment (via, e.g., the ultrasonics control system 300 of FIG. 3A). As used herein, a “vertical-phase” ultrasonic treatment refers to the application of ultrasonics at a delivery angle orthogonal to the major surface 336 (refer to FIG. 3C). In some embodiments, the vertical-phase ultrasonic treatment occurs when the battery component is held under an applied pressure of less than 20 MPa, for example, 5 to 15 MPa. In some embodiments, the vertical-phase ultrasonic treatment occurs at an ultrasonic power of between 20 W and 70 W. In some embodiments, the vertical-phase ultrasonic treatment results in an interface temperature of less than 60 C, for example, between 40 C and 45 C. In some embodiments, the vertical-phase ultrasonic treatment occurs for a processing time of between 30 seconds and 5 minutes. In some embodiments, the vertical-phase ultrasonic treatment occurs at a frequency between 50 kHz (at 70 W) and 200 kHz (at 20 W).

Step 3 represents the battery component after the vertical-phase ultrasonic treatment. The interfacial resistance (Ω) is lowered again, for example, to 150 Ω, with a resistance per unit area of 70 Ω/cm².

As further shown in FIG. 4, between step 3 and step 4 (denoted via the stylized \textcircled{4}), the battery component is subjected to a second lateral-phase ultrasonic treatment (via, e.g., the ultrasonics control system 300 of FIG. 3A). In some embodiments, the second lateral-phase ultrasonic treatment occurs when the battery component is held under an applied pressure of less than 20 MPa, for example, 5 to 15 MPa. In some embodiments, the second lateral-phase ultrasonic treatment occurs at an ultrasonic power of between 20 W and 70 W. In some embodiments, the second lateral-phase ultrasonic treatment results in an interface temperature of less than 60 C, for example, between 40 C and 45 C. In some embodiments, the second lateral-phase ultrasonic treatment occurs for a processing time of between 30 seconds and 5 minutes. In some embodiments, the second lateral-phase ultrasonic treatment occurs at a frequency between 50 kHz (at 70 W) and 200 kHz (at 20 W).

Step 4 represents the battery component after the second lateral-phase ultrasonic treatment. The interfacial resistance (Ω) is lowered again, for example, to 130 Ω, with a resistance per unit area of 68 Ω/cm².

Observe from FIG. 4 that the application of TSMU 400 reduces the interfacial resistance per unit area from thousands of ohms per unit area (e.g., 1388 Ω/cm²) to tens of ohms per unit area (e.g., 68 Ω/cm²). Notably, this outperforms a constant vertical ultrasonic treatment, which has been found to be natively limited to interfacial resistances of hundreds of ohms per unit area, as attempting to target lower resistances results in solid electrolyte cracking that short circuits the underlying device. In other words, even if a constant vertical ultrasonic treatment could theoretically achieve resistances of sub-100 ohms per unit area, such results are not actually achievable due to shorting effects. Without wishing to be bound by theory, the 3-phase lateral-vertical-lateral ultrasonic treatment cycle 400 (that is, the insertion of a vertical-phase between two lateral-phase ultrasonic treatments) has been found to achieve sub-100 resistances while maintaining structural integrity of the solid electrolyte (avoiding cracks).

FIG. 5 illustrates aspects of an embodiment of a computer system 500 that can perform various aspects of embodiments described herein. In some embodiments, the computer system 500 can be incorporated as a system (e.g., the ultrasonic control unit 310 of FIG. 3A) for the production of a battery component (e.g., the battery component 302 of FIG. 3A) of a battery pack (e.g., the battery pack 108 of FIG. 1). The computer system 500 includes at least one processing device 502, which generally includes one or more processors for performing a variety of functions, such as, for example, adjusting one or more parameters of a TSMU process as described herein (e.g., ultrasonic power, ultrasonics processing time and/or frequency, ultrasonics delivery angle, etc.).

Components of the computer system 500 include the processing device 502 (such as one or more processors or processing units), a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media.

For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to monitoring and/or control of the battery pack 108, such as, for example, determining one or more current cell temperatures, a current state of charge for the battery pack 108 and/or any cell of the battery pack 108, a charging duration, a charging current and/or voltage, etc. The computer system 500 is not so limited, as other modules may be included depending on the desired functionality of the vehicle 100. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. For example, the module(s) can be configured via software, hardware, and/or firmware to stop charging and/or otherwise isolate one or more cells of a battery pack of the vehicle 100.

The processing device 502 can also be configured to communicate with one or more external devices 516 such as, for example, a keyboard, a pointing device, and/or any devices (e.g., a network card, a modem, vehicle ECUs, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

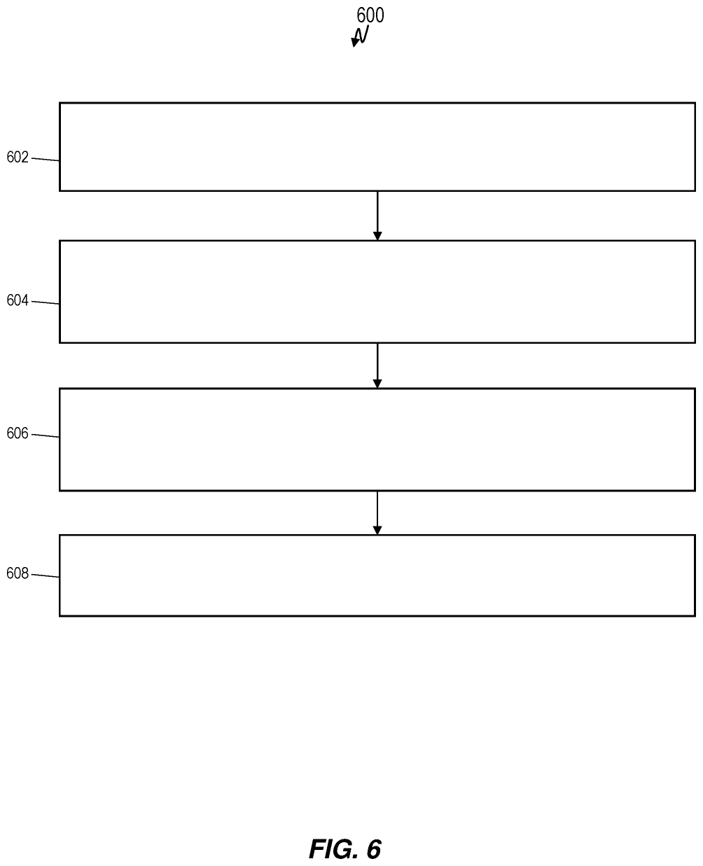

Referring now to FIG. 6, a flowchart 600 for manufacturing solid-state batteries using TSMU is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes receiving a component that includes an anode, a solid electrolyte, and an interface between the anode and the solid electrolyte. The anode includes a major surface.

At block 604, the method includes subjecting the interface to a first ultrasonics phase at an emission angle parallel to the major surface of the anode.

At block 606, the method includes subjecting the interface to a second ultrasonics phase at an emission angle orthogonal to the major surface of the anode.

At block 608, the method includes subjecting the interface to a third ultrasonics phase at an emission angle parallel to the major surface of the anode.

In some embodiments, the first ultrasonics phase includes a lateral ultrasonics phase, the second ultrasonics phase includes a vertical ultrasonics phase, and the third ultrasonics phase includes a lateral ultrasonics phase.

In some embodiments, the first ultrasonics phase, the second ultrasonics phase, and the third ultrasonics phase occur sequentially, thereby defining a tempo-spatial manipulation of ultrasonics (TSMU).

In some embodiments, the TSMU is completed while the component is subjected to an applied pressure of less than 20 MPa. In some embodiments, the applied pressure is constant over the TSMU. In some embodiments, the applied pressure is between 5 MPa and 15 MPa.

In some embodiments, the TSMU is completed at an ultrasonic power of between 20 W and 70 W.

In some embodiments, the TSMU is completed within a processing time of between 30 seconds and 5 minutes.

In some embodiments, the TSMU includes galvanostatic cycling. In some embodiments, the TSMU includes galvanostatic cycling at a constant current density of 0.1 mA/cm².

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
an electric motor; and
a battery pack electrically coupled to the electric motor, the battery pack comprising a solid-state battery cell, the solid-state battery cell comprising:
an anode having a major surface;
a solid electrolyte in direct contact with the anode; and
an interface between the anode and the solid electrolyte;
wherein the interface is subjected to a tempo-spatial manipulation of ultrasonics (TSMU) comprising a first ultrasonics phase at an emission angle parallel to the major surface of the anode, a second ultrasonics phase at an emission angle orthogonal to the major surface of the anode, and a third ultrasonics phase at an emission angle parallel to the major surface of the anode, thereby reducing an air gap between the anode and the solid electrolyte at the interface.

2. The vehicle of claim 1, wherein the first ultrasonics phase comprises a lateral ultrasonics phase, the second ultrasonics phase comprises a vertical ultrasonics phase, and the third ultrasonics phase comprises a lateral ultrasonics phase.

3. The vehicle of claim 1, wherein the first ultrasonics phase, the second ultrasonics phase, and the third ultrasonics phase occur sequentially.

4. The vehicle of claim 1, wherein the TSMU is completed while the anode and the solid electrolyte are subjected to an applied pressure of less than 20 MPa.

5. The vehicle of claim 1, wherein the TSMU is completed at an ultrasonic power of between 20 W and 70 W.

6. The vehicle of claim 1, wherein the TSMU is completed within a processing time of between 30 seconds and 5 minutes.

7. The vehicle of claim 1, wherein the TSMU comprises galvanostatic cycling.

8. A solid-state battery cell comprising:
an anode having a major surface;
a solid electrolyte in direct contact with the anode; and
an interface between the anode and the solid electrolyte;
wherein the interface is subjected to a tempo-spatial manipulation of ultrasonics (TSMU) comprising a first ultrasonics phase at an emission angle parallel to the major surface of the anode, a second ultrasonics phase at an emission angle orthogonal to the major surface of the anode, and a third ultrasonics phase at an emission angle parallel to the major surface of the anode, thereby reducing an air gap between the anode and the solid electrolyte at the interface.

9. The solid-state battery cell of claim 8, wherein the first ultrasonics phase comprises a lateral ultrasonics phase, the second ultrasonics phase comprises a vertical ultrasonics phase, and the third ultrasonics phase comprises a lateral ultrasonics phase.

10. The solid-state battery cell of claim 8, wherein the first ultrasonics phase, the second ultrasonics phase, and the third ultrasonics phase occur sequentially.

11. The solid-state battery cell of claim 8, wherein the TSMU is completed while the anode and the solid electrolyte are subjected to an applied pressure of less than 20 MPa.

12. The solid-state battery cell of claim 8, wherein the TSMU is completed at an ultrasonic power of between 20 W and 70 W.

13. The solid-state battery cell of claim 8, wherein the TSMU is completed within a processing time of between 30 seconds and 5 minutes.

14. The solid-state battery cell of claim 8, wherein the TSMU comprises galvanostatic cycling.

15. A method comprising:
receiving a component comprising an anode, a solid electrolyte, and an interface between the anode and the solid electrolyte, the anode having a major surface;
subjecting the interface to a first ultrasonics phase at an emission angle parallel to the major surface of the anode;
subjecting the interface to a second ultrasonics phase at an emission angle orthogonal to the major surface of the anode; and
subjecting the interface to a third ultrasonics phase at an emission angle parallel to the major surface of the anode.

16. The method of claim 15, wherein the first ultrasonics phase comprises a lateral ultrasonics phase, the second ultrasonics phase comprises a vertical ultrasonics phase, and the third ultrasonics phase comprises a lateral ultrasonics phase.

17. The method of claim 15, wherein the first ultrasonics phase, the second ultrasonics phase, and the third ultrasonics phase occur sequentially, thereby defining a tempo-spatial manipulation of ultrasonics (TSMU).

18. The method of claim 17, wherein the TSMU is completed while the component is subjected to an applied pressure of less than 20 MPa.

19. The method of claim 17, wherein the TSMU is completed at an ultrasonic power of between 20 W and 70 W.

20. The method of claim 17. wherein the TSMU is completed within a processing time of between 30 seconds and 5 minutes.
